(19) United States
(12) Patent Application Publication
(10) Pub. No.: US 2001/0043740 A1
(43) Pub. Date: Nov. 22, 2001

(54) Character recognizing device, image reading device, character recognizing method, and program product

(76) Inventors: Yukihiko Ichikawa, Chiba-Shi (JP); Yoshinori Tanaka, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/858,946

(22) Filed: May 17, 2001

(30) Foreign Application Priority Data
May 17, 2000 (JP) 2000-145514

(51) Int. Cl. G06K 9/34; G06K 9/00

(52) U.S. Cl. 382/176; 382/181

(57) ABSTRACT

The digital copying machine 14 includes the character recognizing unit 31 that recognizes character strings included in table areas extracted from the image, the table operational unit 34 that calculates based on the numerical data obtained by converting character strings consisting of numbers and the operational expressions defined according to the specific character strings, and the verification unit 35 that compares the calculated values calculated by the table operational unit 34 with the numerical data to be verified. If a calculated value and a corresponding numerical data do not match, the control unit 26 notifies the user about the mismatch. The user can easily check recognition errors of numbers or errors in preparing the original document.

This application is based on Japanese Patent Application No. 2000-145514 filed on May 17, 2000, the contents of which are hereby incorporated by reference.

### BACKGROUND OF THE INVENTION

1. Filed of the Invention

The invention relates to character recognition technology for recognizing characters from images and checking calculations of numerical data in tables.

2. Description of the Related Art

The optical character recognition (OCR) technology has been known for a while in which documents are read by scanners, strings of characters are recognized from the scanned images, table layout formats are recognized, etc. For example, the Publication of Unexamined Patent Application No. JP-A-2-61775 discloses an image recognition technology that extracts table areas from an image and rectangular frames surrounded by ruled lines. The Publication of Unexamined Patent Application No. JP-A-5-334490 discloses an image recognition technology for recognizing the structures of tables based on positional relations between extracted character blocks.

Although the accuracy of character recognition is improving, it has not yet reached a level where it recognizes characters perfectly without making any errors.

If a character string consists of kanji, hiragana, katakana, alphabet characters, and the like, the user can easily detect erroneously recognized characters from the context or with the help of the user's knowledge of terms.

On the other hand, if a recognized character string consists of numbers, it is difficult to judge whether the numbers are correctly recognized, as the numbers have no relations between them. Even one area of numbers of a table is mistakenly recognized, it is difficult for the user to realize such a mistake as similar number strings appear in the table. In case of character strings consisting of numbers, the only way of detecting errors is to compare the recognized result with the original. This is a complex and time-consuming work. Therefore, it is strongly desirable to find a way to simplify the procedure of checking correctness of number recognition results and improve the efficiency of such a work. Also, in some cases, the numbers written on the original document itself may be wrong. In copying a document, or using an application that performs an OCR process, it would be very convenient if any typographical errors in the original document can be checked. However, there has been any prior art that is capable of checking errors in number recognitions or typographical errors in numbers of the document.

### SUMMARY OF THE INVENTION

The present invention was made in consideration of such a condition and the object of the invention is to provide a character recognition technology intended for checking errors in number recognitions or typographical errors in numbers of the document.

According to an aspect of the invention we provide a character recognition device comprising: an extracting unit that extracts table areas from an image; a character recognizing unit that recognizes character strings included in said table areas; a converting unit that converts character strings consisting of numbers from the recognized character strings into numerical data; a defining unit that defines operational expressions based on specific character strings from the recognized character strings; an operational unit that calculates based on said numerical data and said operational expressions; a comparing unit that compares calculated value provided by said operational unit with said numerical data; and a reporting unit that reports mismatches when there are mismatches between said calculated value and said numerical data.

According to another aspect of the invention we provide an image reading device comprising: a reading unit that reads a document and outputs its image data; an extracting unit that extracts table areas from the outputted image data; a character recognizing unit that recognizes character strings included in said table areas; a converting unit that converts character strings consisting of numbers from the recognized character strings into numerical data; a defining unit that defines operational expressions based on specific character strings from the recognized character strings; an operational unit that calculates based on said numerical data and said operational expressions; a comparing unit that compares calculated value provided by said operational unit with said numerical data; a forming unit that forms an image that reports mismatches when there are mismatches between said calculated value and said numerical data; and an output unit that outputs the image formed by the forming unit.

According to still another aspect of the invention we provide a character recognition method comprising the steps of: 1) extracting table areas from an image; 2) recognizing character strings included in said table areas; 3) converting character strings consisting of numbers from the recognized character strings into numerical data; 4) defining operational expressions based on specific character strings from the recognized character strings; 5) calculating based on said numerical data and said operational expressions; 6) comparing calculated value with said numerical data; and 7) reporting mismatches when there are mismatches between said calculated value and said numerical data.

According to still another aspect of the invention we provide a storage medium readable by a computer for storing a program operable to recognize characters, the program comprising: an extracting means that extracts table areas from an image; a character recognizing means that recognizes character strings included in said table areas; a converting means that converts character strings consisting of numbers from the recognized character strings into numerical data; a defining means that defines operational expressions based on specific character strings from the recognized character strings; an operational means that calculates based on said numerical data and said operational expressions; a comparing means that compares calculated value provided by said operational means with said numerical data; and a reporting means that reports mismatches when there are mismatches between said calculated value and said numerical data.

According to still another aspect of the invention we provide a computer program product for recognizing characters, the computer program products comprising: a computer usable medium having computer readable program means embodied in said medium, said computer readable program means comprising: an extracting means that extracts table areas from an image; a character recognizing means that recognizes character strings included in said table areas; a converting means that converts character strings consisting of numbers from the recognized character strings into numerical data; a defining means that defines operational expressions based on specific character strings from the recognized character strings; an operational means that calculates based on said numerical data and said operational expressions; a comparing means that compares calculated value provided by said operational means with said numerical data; and a reporting means that reports mismatches when there are mismatches between said calculated value and said numerical data.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a constitutional drawing showing the constitution of an image forming system;

FIG. 2 is a block diagram showing the constitution of a digital copying machine;

FIG. 3 is a drawing showing a table recognized through the OCR process;

FIG. 4A is an example of a table included in a document and

FIG. 4B is a table recognized by OCR processing of the table shown in FIG. 4A, wherein “6” in the thousand's place of the number shown in the total cell is mistakenly recognized as “8”;

FIG. 5 is a drawing showing another example of a table recognized by OCR processing;

FIG. 6 is an example of a table format;

FIG. 7 is an example of an operation table;

FIG. 8 is an example of a verification table;

FIG. 9 is an example of an operational expression table;

FIG. 10 is a main flow chart describing the action of this embodiment;

FIG. 11 is a flow chart showing a procedure of the verification process;

FIG. 12 is a flow chart showing a second table operational procedure;

FIG. 13 is a chart showing an example of a table included in an original document together with histograms representing the distributions of black pixels in the horizontal and vertical directions; and

FIG. 14A through FIG. 14E are used to describe procedures of identifying table areas and extracting rectangular frames.

### DETAILED DESCRIPTION OF THE PREFERRED EMBODIMENT

The embodiment of the invention will be described below referring to the accompanying drawings.

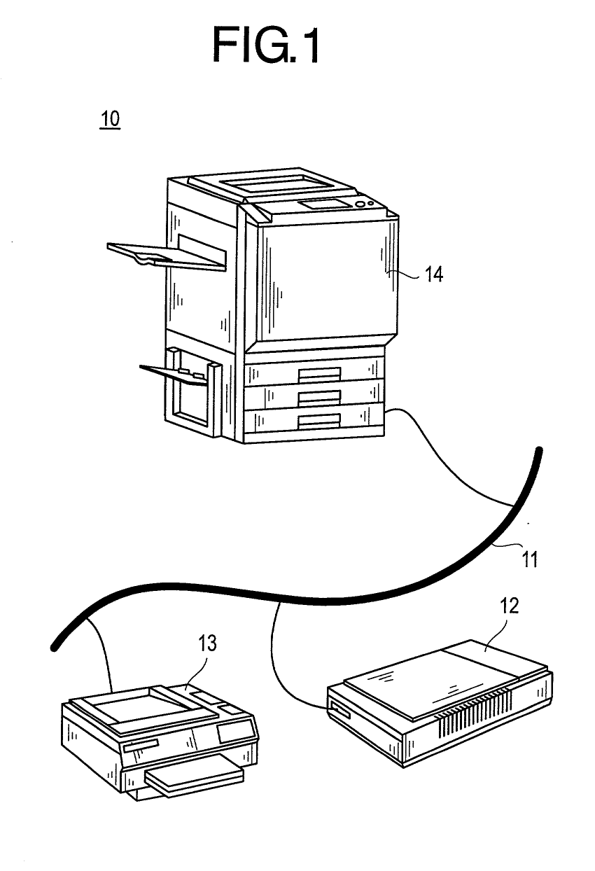

In FIG. 1, an image forming system 10 is connected to a scanner 12 that scans a document and outputs its image data, a printer 13 that prints the image, and a digital copying machine 14 through a network 11. The image read by the scanner 12 can be printed not only by the printer 13 but also by the digital copying machine 14. The digital copying machine 14 can not only scan a document and print its image, but also send the scanned image to the printer 13 or other computers not shown here via the network 11. The invention is applied on the digital copying machine 14.

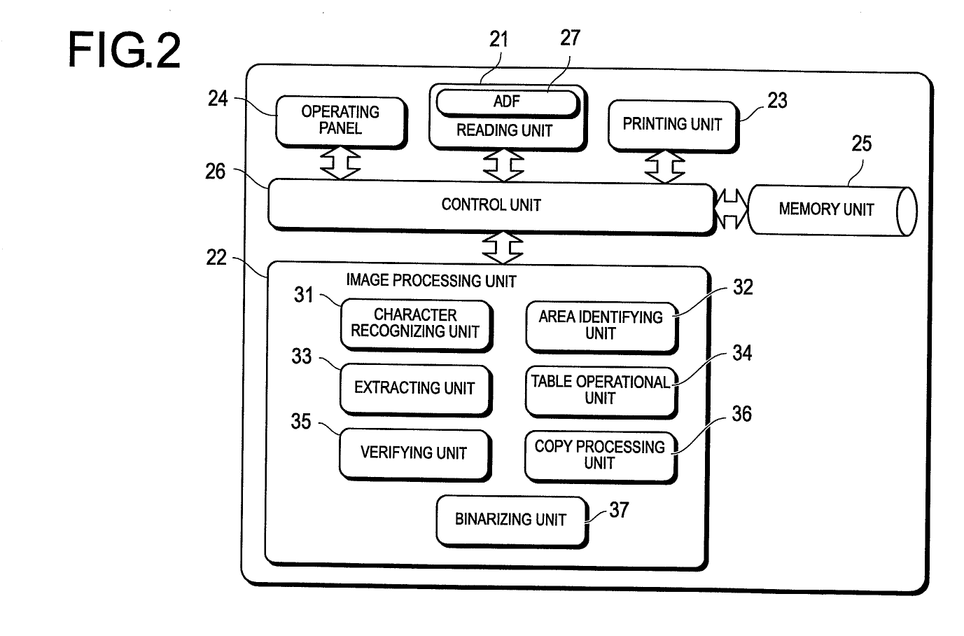

As shown in FIG. 2, the digital copying machine 14 includes a reading unit 21 that reads documents and outputs their image data, an image processing unit 22 that processes the outputted image data, a printing unit 23 that prints the processed images, an operating panel 24 that is key-operated by the user, a memory unit 25, and a control unit 26 that controls other units.

A reading unit 21 is equipped with an automatic document feeder (ADF) 27. Multiple sheets of documents stacked on the ADF 27 are transported to the specified reading position one by one. The operating unit 24 is provided with a liquid crystal touch panel that displays various screens, a ten-key unit for instructing the number of copies to be made, etc., a start key for starting the operation, and a stop key for stopping the operation. The user operates the operating panel 24 to switch display screens and copying modes as well as inputting the number of copies to make.

The image processing unit 22 has a character recognizing unit 31, a area identifying unit 32, an extracting unit 33, a table operational unit 34, a verifying unit 35, a copy processing unit 36, and binarizing unit 37.

The character recognizing unit 31 takes out character images one by one from the scanned image, recognizes said character image, and converts them into character code data. The character recognizing unit 31 identifies the character images included in the text area and the table area as the objects of character recognition. The recognizable characters include all the characters, numbers and symbols to which character code data are assigned as well as external characters the user might have registered based on the user's own patterning actions. The character recognizing unit 31 recognizes fonts and font sizes as well.

The area identifying unit 32 identifies text areas, graphic areas, and table areas that are included in an image and divides the image into separate areas. The text areas are areas that contain only character strings. The graphic areas are areas that contain graphics and photographs that cannot be recognized as characters. The table areas are areas that contain rectangular frames surrounded by ruled lines and characters placed within said rectangular frames.

The extracting unit 33 extracts table areas by recognizing ruled lines of the table areas, as well as each rectangular cell that constitutes each table.

The table operational unit 34 converts character strings consisting of numbers from the character strings recognized in the table areas into numerical data. The table operational unit 34 defines operational expressions based on specific character strings from the recognized character strings. The table operational unit 34 further executes specified operations based on the defined operational expressions and the converted numerical data.

The verifying unit 35 compares the calculated value processed by the table operational unit 34 with the numerical data, which are the objects of the verification, and makes a judgment whether the calculated value match with the numerical data. The control unit 26 reports the fact that a particular calculated value does not match with a corresponding numerical data if that happens. This verifying unit 35 and said table operational unit 34 function together as an identifying means for identifying mistaken recognitions by the character recognizing unit 31.

The copy processing unit 36 executes image copying processes such as smoothing and edge enhancement processes, while binarizing process unit 37 performs binarizing processes against inputted images.

The memory unit 25 stores parameters required for image processing and various data required for operations and verification processes of the numerical data in the table.

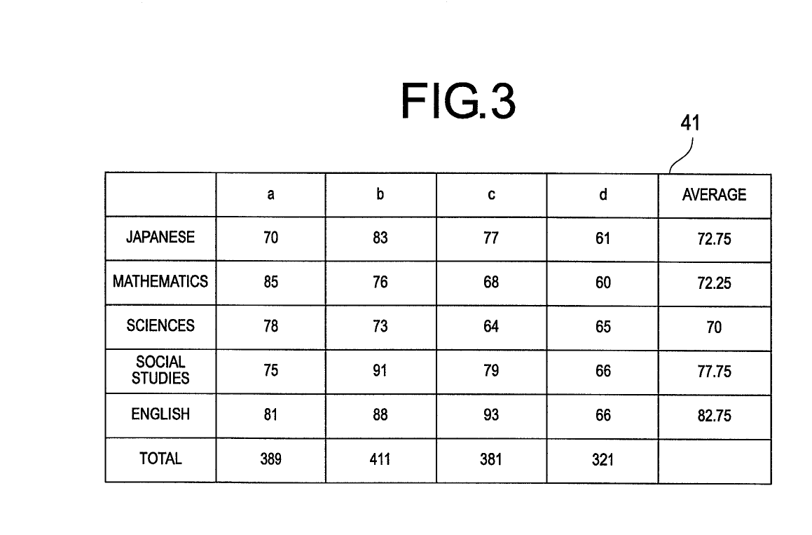

A table 41 shown in FIG. 3 is a table recognized by the OCR process.

The recognized table 41 is constructed as a table of 7 rows×6 columns. For the convenience of explanation, let us call the topmost row as the first row, which is followed by the second, third and so on to seventh rows in a downward sequence. Also, let us call the leftmost column as the column A, which is followed by the columns B, C and so on to F in a rightward sequence. The position of each cell of the table can be specified by the name of the column and the number of row, and a cell is called in such a way as the “cell [B2].” The character string “70” is recognized in the cell [B2].

The first column (column A) of the table 41 is assigned for row labels that represent the headings of the rows. The first row of the table 41 is assigned for column labels that represent the headings of the columns. In the second through sixth rows of the first column, the character strings that represent the headings of the respective rows such as “Japanese,” “mathematics,” “sciences,” “social studies,” and “English” are recognized. In the cell [A7], a character string “total” that specifies the kind of operation is recognized. Let us call the character strings that specify the kinds of operations as “specific character strings.” In the columns B through E of the first row, the character stings that represent the headings of the respective columns such as “a,” “b,” “c,” and “d” are recognized. A specific character string “average” is recognized in the cell [F1]. In the rest of the cells, character strings consisting of numbers are recognized as shown in the drawing.

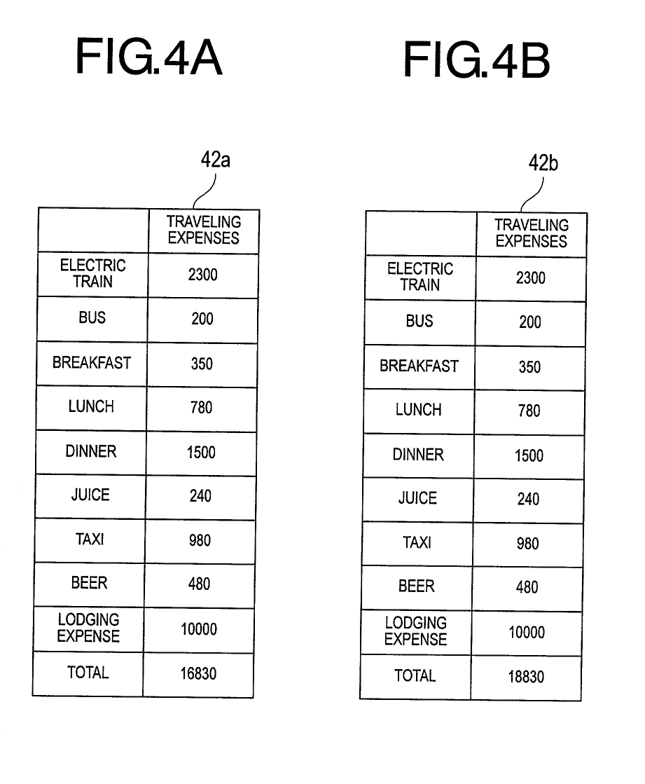

A table 42b shown in FIG. 4B is a table recognized by OCR processing a table 42a shown in FIG. 4A and has a table structure of 11 rows×2 columns. Character strings, “electric train,” “bus,” . . . “lodging expense,” that represent the row headings are recognized in the second through 10th rows of the first column. A specific character string “total” is recognized in the cell [A11]. A character string “traveling expenses” that represent the column heading is recognized in the column B of the first row. No specific character string exists in the column labels. In the table 42b, “6” in the thousand's place of the number shown in the total cell ([B11]) is mistakenly recognized as “8.”

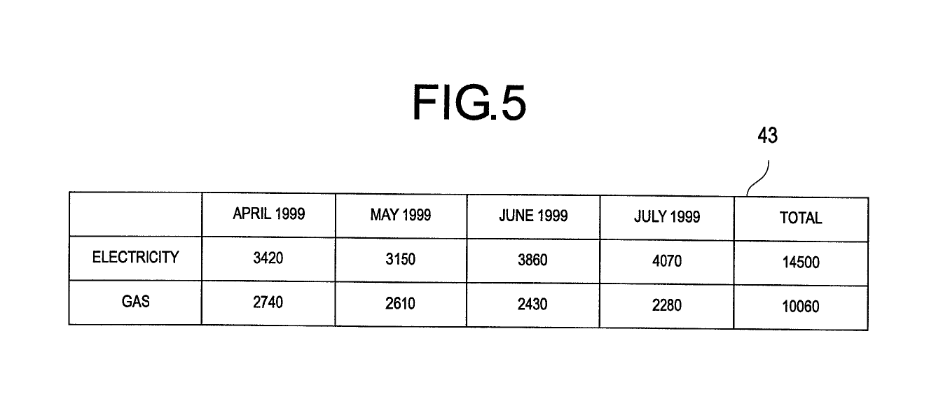

A table 43 shown in FIG. 5 is a table recognized by the OCR process and has a table structure of 3 rows×6 columns. Character strings, “electricity” and “gas,” that represent the row headings are recognized in the second and third rows of the first column. No specific character string exists in the row labels. Character strings, “April 1999” . . . “July 1999,” that represent the column headings are recognized in the column B through E of the first row. A specific character string “total” is recognized in the cell [F1].

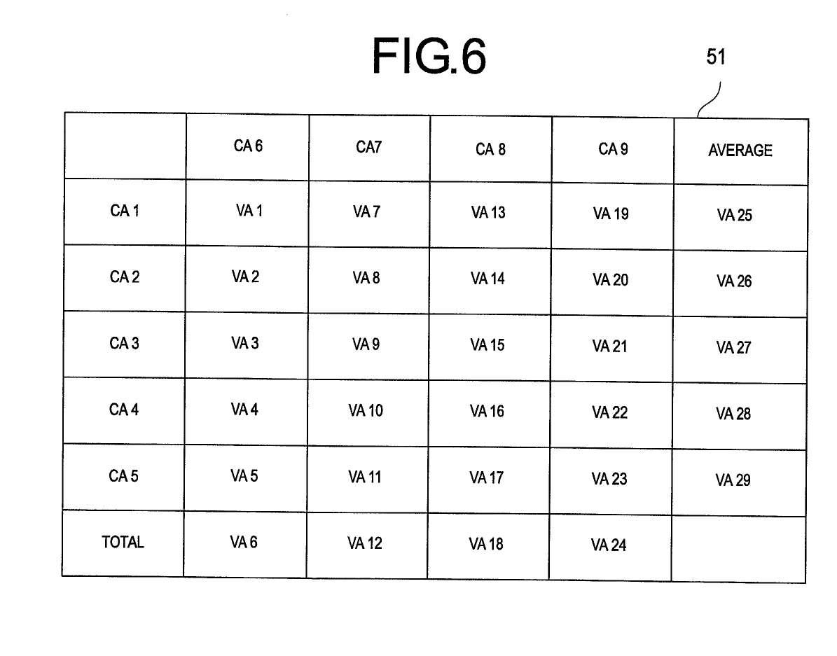

The memory 25 stores multiple table formats 51, one of which is shown as an example in FIG. 6. The table format contains a table structure and specific character strings. Specific character strings contain such characters as “average,” “total,” “sum,” or “subtotal.”

The table format 51 shown in FIG. 6 has a table structure of 7 rows×6 columns. The first through fifth character areas, i.e., CA1 through CA5, to which arbitrary character strings can be disposed, are assigned to the second through sixth rows of the first column. A specific character string “total” is assigned to the cell [A7]. The sixth through ninth character areas, i.e., CA6 through CA9, to which arbitrary character strings can be disposed, are assigned to the columns B through E of the first row. A specific character string “average” is assigned to the cell [F1]. The rest of the cells are assigned as the first through 29th numerical value areas, i.e., VA1 through VA29, to which arbitrary numerical data can be assigned. Therefore, the table 41 shown in FIG. 3 and the table format 51 shown in FIG. 6 share a matching table structure and matching specific character strings.

In this embodiment, table formats that match with the table 42b and table 43 shown in FIG. 4B and FIG. 5 respectively are not stored in the memory unit 25.

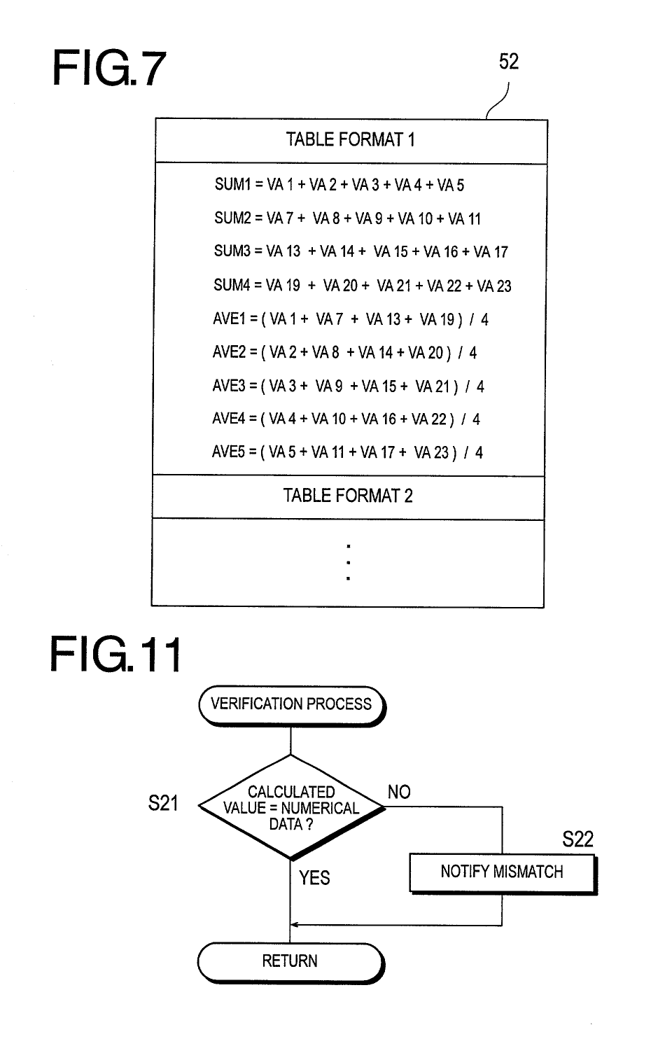

The memory unit 25 stores a first operational table 52, an example of which is shown in FIG. 7. The first operational table 52 is a table that describes operational expressions corresponding to each table format. FIG. 7 shows a portion of the first operational table 52 that describes operational expressions for the table format 51.

A specific character string “total” exists in the cell [A7] of the table format 51. In correspondence with it, the first operational table 52 has several operational expressions for conducting operations in the column direction. For example, the first operational table 52 has an operational expression that sets the value calculated by adding each numerical data in the first through fifth numerical value areas, VA1 through VA5, to a variable SUM1. Similar relations hold for SUM2, 3 and 4. A specific character string “average” exist in the cell [F1] of the table format 51. In correspondence with it, the first operational table 52 has several operational expressions for conducting operations in the row direction. For example, the first operational table 52 has an operational expression that sets the value calculated by dividing the sum of each numerical data in the first, seventh, 13th and 19th numerical value areas, VA1, 7, 13 and 19, with the number of data 4 to a variable AVE1. Similar relations hold for AVE2, 3, 4 and 5.

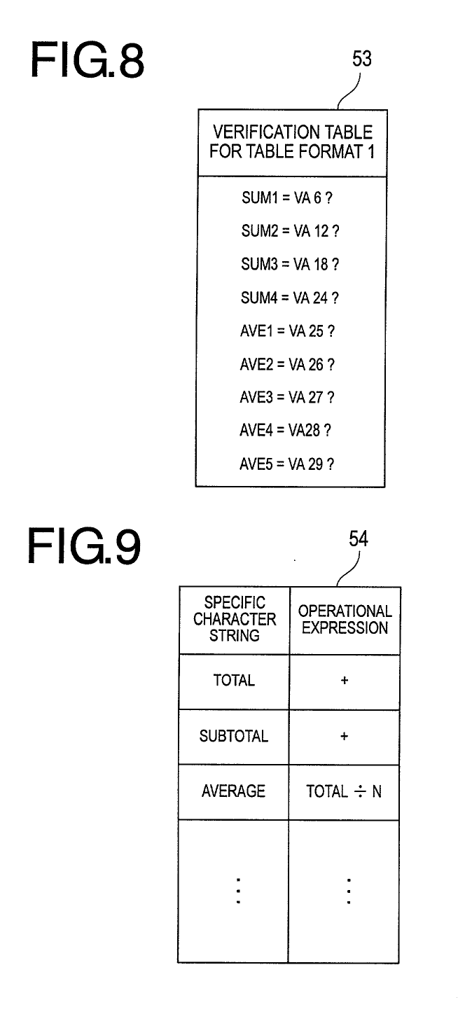

The memory unit 25 stores a verification table 53, an example of which is shown in FIG. 8. The verification table 53 describes the verification expression for each table format. FIG. 8 shows the verification expression for the table format 51, which is a portion of the verification table 53.

A verification expression is described for the verification of the column B wherein the calculated value set as the variable SUM1 is compared with the numerical data of the sixth numerical value area VA6. Similar relations hold for the columns C, D and E. A verification expression is described for the verification of the second row wherein the calculated value set as the variable AVE1 is compared with the numerical data of the 25th numerical value area VA25. Similar relations hold for the third, fourth, fifth and sixth rows.

The memory unit 25 stores the second operational table 54, an example of which is shown in FIG. 9. The second operational table 54 describes specific character strings as well as operational expressions and arithmetic operators (generically called operational expressions). Specific character strings contain such characters or character strings as “average,” “total,” “sum,” or “subtotal” as mentioned before. An operational expression “+” for addition is described for the specific character strings “total” or “subtotal.” An operational expression “total÷N” for dividing the total by the number of items N is described for the specific character string “average.”

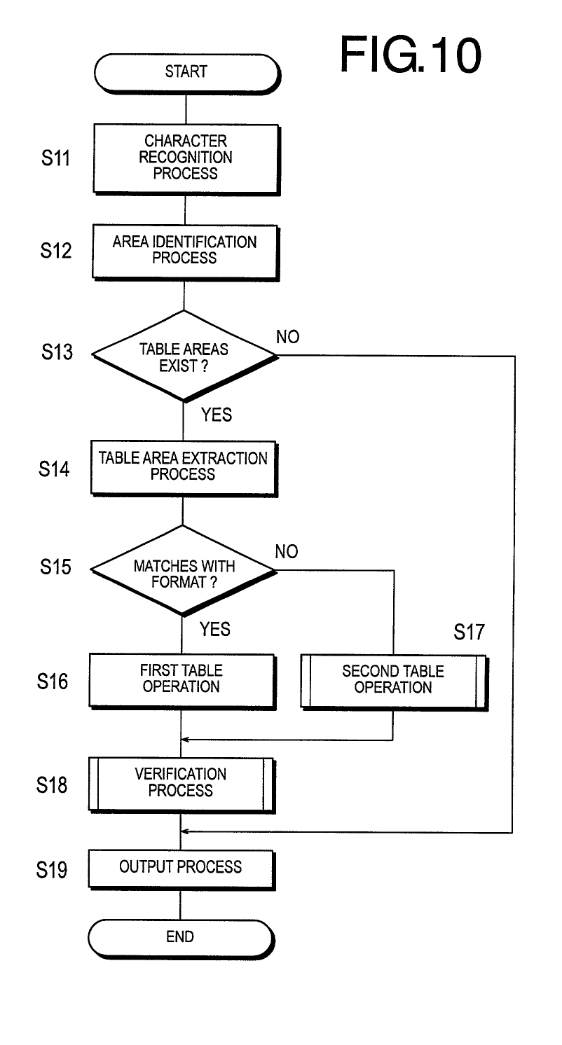

The operation of the digital copying machine 14 according to this embodiment will be described below referring to the main flow chart shown in FIG. 10.

The reading unit 21 reads the document and outputs its image data and the character recognizing unit 31 performs a character recognition process on the outputted image data (S11). Next, the area identifying unit 32 identifies text areas, graphic areas, and table areas and divide the image into each area (S12).

If no table area exists (S13: No), the output process will be executed (S19). In other words, the image data will be processed with normal copy image processes such as edge enhancing and smoothing, processed further with a binarizing process, and then printed.

If table areas exist (S13: Yes), the extracting unit 33 executes a process of extracting table areas from images (S14). In this process, rectangular frames surrounded by ruled lines will be extracted from the table areas. The character recognition unit 31 cuts out character images surrounded by their own rectangular frames one by one, identifies corresponding character images and converts them into character code data. Of the recognized character strings, character strings consisting of numbers (e.g., Arabic figures) are converted into numerical data by the table operational unit 34.

The table operational unit 34 makes a judgment whether any table formats exist in the stored table formats that match with a recognized table (S15). This judgment is made by comparing the table structure determined by the positional relations among the rectangular frames in the table area with the structure of each table format and then comparing the specific character stings that are determined based on the recognized character strings with the character strings set on the table format.

If there is a table format is found to be stored in the memory unit 25 that matches with the recognized table, it is determined that the recognized table matches with the table format (S15: Yes), and the first table operation will be executed (S16). If no table format that matches with the recognized table is found to be stored in the memory unit 25, it is determined that there is no match (S15: No), and the second table operation will be executed (S17).

In the first table operation (S16), the table operational unit 34 selects the matched table format. The table operational unit 34 retrieves operational expressions that match with the selected table format from the first operational table 52 and defines them. The table operational unit 34 calculates the numerical data based on the defined operational expressions. Furthermore, the table operational unit 34 calls verification expressions that correspond with the selected table format from the verification table 53 and define them.

In the second table operation (S17), the table operational unit 34 selects operational expressions that match with the specific character strings contained in the recognized tables, retrieve them from the second operational table 54, and define them. The table operational unit 34 identifies the positions that the specific character strings exist in a table where they exist. The table operational unit 34 calculates numerical data based on the defined operational expressions in the directions corresponding to the positions of the specified character strings in the table. The verifying unit 35 defines the numerical data to be verified in correspondence with the positions of the specified character strings.

Next, the verifying process is executed (S18). The numerical data to be verified are compared with the calculated values by the verifying unit 35 in the verifying process (S18). Later, the output process will be executed (S19).

The procedures for the table area identifying process (S12) and the rectangular frame extracting process (S14) will now be described.

Several methods of identifying table areas and extracting rectangular frames have been known including the method of using the distribution of black pixels (e.g., the Publication of Unexamined Japanese Patent Application No. JP-A-2-61775) and the method of converting the ruled lines that constitute tables into vector line segments. In this embodiment, the method of using the distribution of black pixels is used to identify table areas and extract rectangular frames.

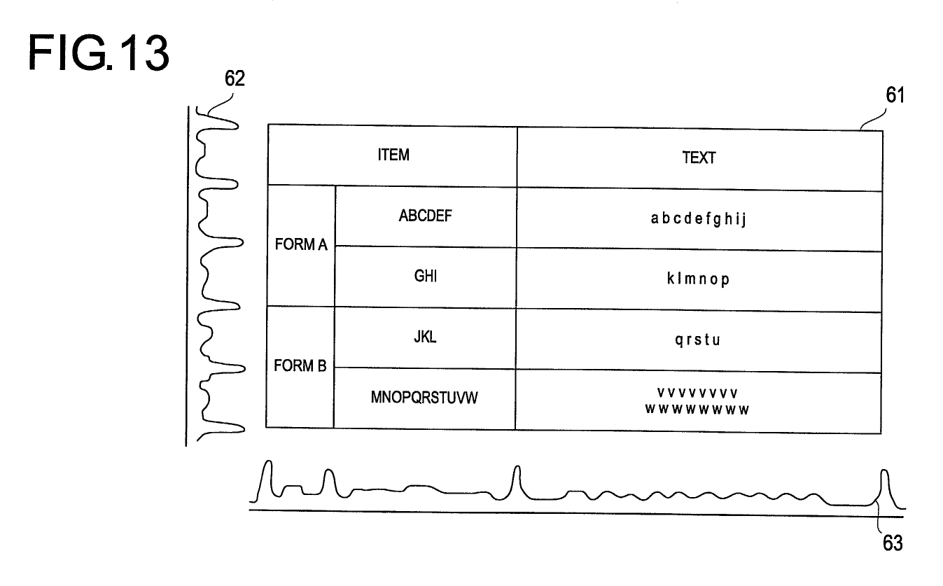

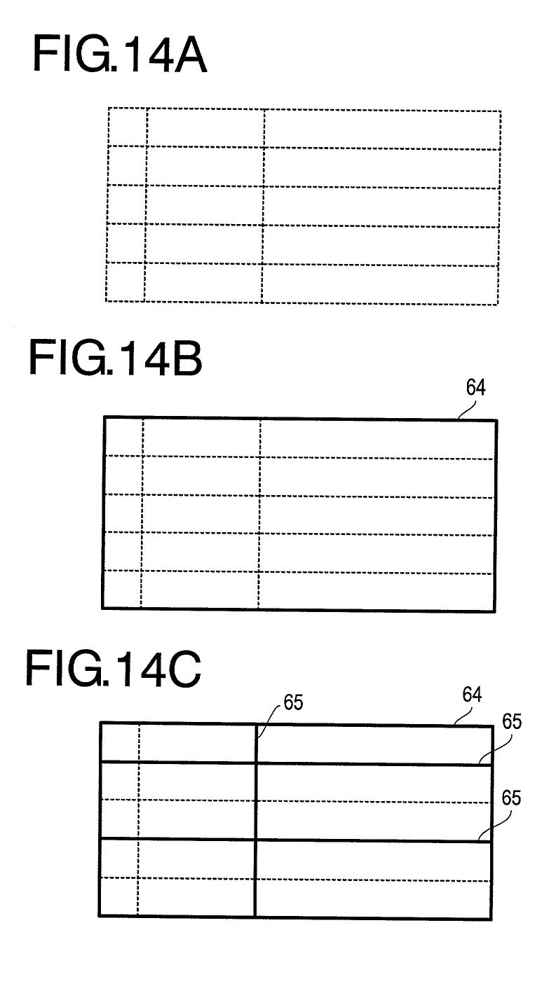

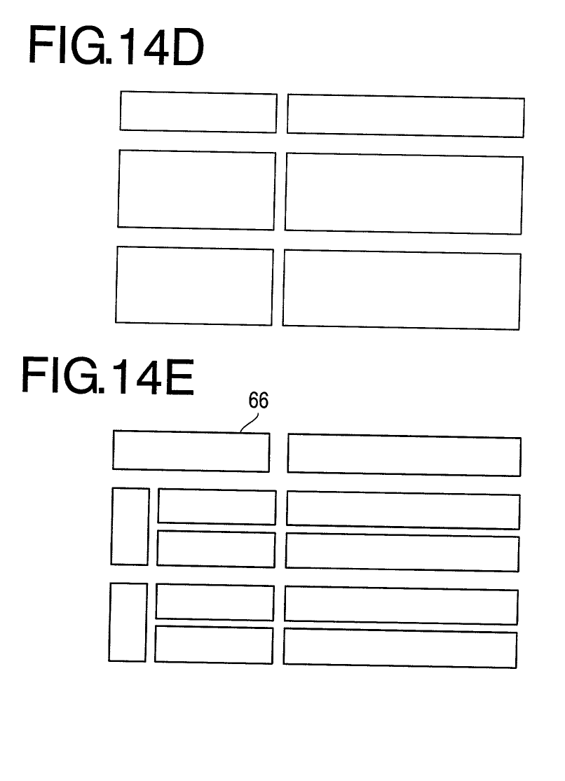

In FIG. 13, the histogram obtained by taking distribution of the black pixels in the horizontal direction is coded as “62,” while the histogram obtained by taking distribution of the black pixels in the vertical direction is coded as “63.” In FIG. 14A through FIG. 14E, the ruled line candidates are indicated by broken lines while the finalized ruled lines are indicated by solid lines.

As shown in FIG. 13, peripheral distributions are determined in both the horizontal and vertical directions for the entire image. The histogram curves peak at those places where a large amount of black pixels exists. Also, since the width of a ruled line is sufficiently narrower than the size of a character, a peak with a wide width suggests the existence of a character, while a peak with a narrow width suggests the existence of a line. Thus, the positions of peaks with heights over a prescribed threshold value are suspected as the positions of both the horizontal and vertical ruled lines; thus the ruled line candidates are extracted. FIG. 14A shows such extracted ruled line candidates.

Next, outer frame lines 64 will be determined as shown in FIG. 14B based on the extracted ruled line candidates. The area surrounded by the outer frame lines 64 is also identified as the table area.

Next, as shown in FIG. 14C, among the ruled line candidates extracted as shown in the above, those ruled line candidates that abut with the outer frame lines 64 on both ends are obtained as ruled lines 65. Then, various blocks that are surrounded by these ruled lines 64 and 65 are extracted as shown in FIG. 14D.

By repeating processes similar to the above to those extracted blocks, blocks surrounded by ruled lines are divided sequentially. When the dividing process can no longer find any ruled lines within any blocks, then the block is adopted as a rectangular frame surrounded by ruled lines. FIG. 14E shows those rectangular blocks 66 extracted from the image by reading the table shown in FIG. 13.

The first table operation (S16) and the verifying process (S18) will now be described in detail using the table 41 shown in FIG. 3 as an example. FIG. 11 is a flow chart showing the procedure of the verifying process.

In case of the table 41 shown in FIG. 3, it is judged that it matches with the table format 51 shown in FIG. 6 (S15: Yes), and the first table operation is executed (S16). As the operational expressions for the table format 51, the operational expressions described in the first operational table 52 shown in FIG. 7 are to be used. Operations are executed according to the operational expressions. For example, as to SUM1, character strings consisting of numbers disposed in the first through fifth numerical value areas VA1 through VA5 are converted into numerical data, so that the numerical data of the first numerical value area VA1+the numerical data of the second numerical value area VA2+the numerical data of the third numerical value area VA3+the numerical data of the fourth numerical value area VA430 the numerical data of the fifth numerical value area VA5 can be calculated. In other words,

SUM1←70+85+78+75+81

is calculated. Similarly,

SUM2←83+76+73+91+88

SUM3←77+68+64+79+93

SUM4←61+60+65+66+69

AVE1←(70+83+77+61)/4

AVE2←(85+76+68+60)/4

AVE3←(78+73+64+65)/4

AVE4←(75+91+79+66)/4

AVE5←(81+88+93+69)/4

are calculated.

As the verification expressions for the table format 51, the verification expressions described in the verification table 53 of FIG. 8 are used. The following comparisons are made according to the verification expressions. As to SUM1, the character string consisting of numerical data disposed in the sixth numerical value area VA6 is converted into a numerical data and the calculated value set in SUM1 and the numerical data of the sixth numerical value area VA6 are compared (S21 of FIG. 11). In other words,

SUM1 and 389

are compared. Similarly,

SUM2 and 411

SUM3 and 381

SUM4 and 321

AVE1 and 72.75

AVE2 and 72.25

AVE3 and 70

AVE4 and 77.75

AVE5 and 82.75

are compared.

As a result of the comparison by the verifying unit 35, it is judged that the calculated value set in SUM1 and the numerical data of the sixth numerical value area VA6 are equal. Similarly in SUM2 through AVE5, the calculated value and the numerical data are judged to be equal. If all the calculated value and the numerical data are coinciding (S21: Yes), it can be said that the numbers have been correctly recognized without any erroneous recognitions in the OCR process, or the numbers in the original document are written correctly. When the verification results confirm “correctness” as described in the above, the result of the character recognition is outputted as is (S19).

Let us think about a case where the calculated values set in SUM1 does not match with the numerical data in the sixth numerical value area VA6. Mismatching between the calculated value and the numerical data can occur due to either that (1) there was a recognition error in the number recognition stage, or that (2) there was an error in preparing the original document itself.

Therefore, if the calculated value does not match with the numerical data to be verified (S21: No), the control unit 26 reports to the user that the calculated value does not match with the numerical data (S22). More specifically, the control unit 26 operates the copy processing unit 36 and forms an image by changing the color attribute of the character string disposed in the sixth numerical value area VA6 and by modifying the font attribute of the character string. The control unit 26 outputs the formed image to the printing unit 23 and the printing unit 23 prints the image outputted from the control unit 26. It is possible to modify the color attributes and the font attribute of all the character strings that are disposed in the column B. The control unit 26 can report to the user that there are mismatches by displaying error messages on the operating panel 24.

This report will allow the user to grasp the fact quickly and easily that an error has occurred in character recognition or preparation of the original document. Moreover, the user can see the rows or the columns to be checked thus simplifying and expediting the correction work thereafter.

The second table operation (S17) and the verification process (S18) will be described by using the tables 42b and 43 shown in FIGS. 4B and 5 as examples.

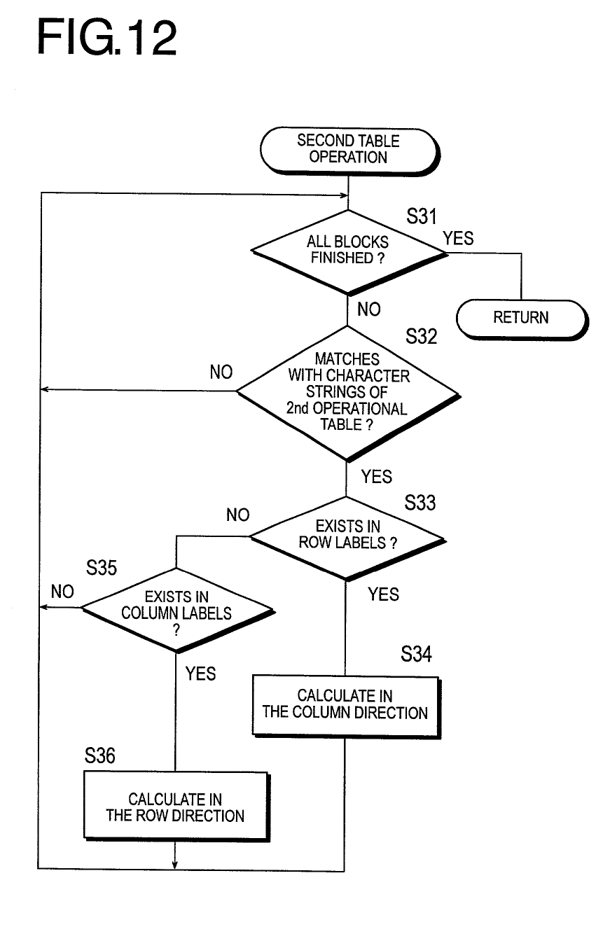

With reference to the flow chart shown in FIG. 12, a judgment is made whether there are any character strings in the recognized table that match with the character strings stored in the second operational table 54 (S31: No, S32). If there are any matching character strings (S32: Yes), the table operational unit 34 selects operational expressions whose specific character strings match, retrieve the selected operational expressions from the second operational table 54, and define them.

The character strings “total” appearing in the tables 42b and 43 shown in FIGS. 4B and 5 match with the character strings stored in the second operational table 54. The operational expression “+” for addition is defined in correspondence with the specific character string “total.”

Next, the positions in the table where the specific character strings exist are identified by the table operational unit 34 (S33, S35). In case of the table 42b, the specific character string “total” is identified to exist in the lowest row of the first column (cell [A11]). In case of the table 43, the specific character string “total” is identified to exist in the column F of the first row (cell [F1]).

If a specific character string exists in the first column, i.e., among the row labels (S33:Yes), the table operational unit 34 calculates in the column direction according to the defined operational expressions (S34). The calculation in the column direction is repeated to the row next to the row where the specific character string exits. In case of 42b, the operation of adding numerical data is repeated in the column direction. In other words, the calculation of 2300+200+350+780+1500+240+980+480+10000 for the column B.

If a specific character string exists in the first row, i.e., among the column labels (S33: No, S35: Yes), the table operational unit 34 calculates in the row direction according to the defined operational expression (S36). The calculation in the row direction is repeated to the column next to the column where the specific character string exits. In case of 43, the operation of adding numerical data is repeated in the row direction. In other words, the calculation of 3420+3150+3860+4070 for the second row.

In the verification process (S18), the calculated value and the numerical data in the next cell are compared by the verifying unit 35.

In case of the table 42b, the calculation is being done in the column direction so that the “next cell” means the cell [B11]. Therefore, the calculated value obtained by adding the numerical data from the second row to the 10th row of the column B and the numerical data of the cell [B11], i.e., “18830,” are compared. In the example shown, “16830” of the original document is recognized erroneously as “18830,” the calculated valued and the numerical data do not match. Therefore, the character string in the cell [B11] will be printed in different color by changing the color attributes to warn the user about the data mismatch (S22). The user can grasp the fact quickly and easily that an error has occurred in character recognition or preparation of the original document. Moreover, the user can see the area to be checked thus simplifying and expediting the correction work thereafter.

In case of the table 43, the calculation is being done in the row direction so that the “next cell” means the cell [F2]. The calculated value obtained by adding the numerical data from the columns B through E of the second row and the numerical data of the cell [F2], i.e., “14500,” are compared. Since the calculated value and the numerical data match, the result of the character recognition is outputted as is (S19).

As described in the above, the digital copying machine 14 of the embodiment not only copies a document with tables but also simultaneously compares calculated values with numerical data to be verified, and notifies the user about errors if they do not match. Thus, the digital copying machine 14 is a very convenient tool for finding recognition errors or errors made in preparing the original document. It also makes it unnecessary to try to find number recognition errors by comparing the original document with the character recognition result. Thus, it simplifies the user's checking of the result of number recognition, reduces the user's labor and improves the productivity.

The invention is not restricted to various embodiments described above, and various modifications and changes can be made without deviating from the technological concept of the invention.

For example, if the calculated value and the numerical data to be verified do not match, in addition to the report about the data mismatch, it can be so arranged to reconvert the calculated value to a character string to replace said numerical data in the corresponding cell. Such an arrangement makes it possible to automatically correct the errors in the columns and rows where the specific character strings exist.

There may be a case where the calculated value and the numerical data to be verified do not match as a result of the fact that a character string used for the calculation is erroneously recognized or written despite the fact that the numerical data to be verified is correct. Therefore, it is preferable to make the abovementioned correction according to the user's instruction after inquiring the user whether an automatic correction of numbers should be made. It is also possible to make the cells and numbers to be specified by the user.

When a table is prepared using a table calculation application, totals and averages are automatically calculated. Therefore, if a calculated value and a numerical data do not match as a result of verification, there is a high probability that the character string used for the calculation is erroneously recognized. In such a case, in addition to the report about the data mismatch, the images of mismatching areas will be cut out from the scanned image and the cut out images will be pasted on other areas and printed. This prevents the information from being printed containing recognition errors.

Although it was shown in the above the cases where table formats and operational expressions are automatically selected and set up, it is also possible to arrange in such a way as to allow the user operate the operating panel unit 24 to select and/or set up table formats, operational expressions for each table format, specific character strings and operational expressions for each specific character string arbitrarily.

Although it was described in the above that the table format 51 stored in the memory unit 25, it is also possible to constitute in such a way as to allow the user to prepare a table format by means of a personal computer and the like, and make the prepared table format downloadable into the memory unit 25 via the network. It is also possible to constitute in such a way as to allow the user to prepare the first operational table 52, the verification table 53, and the second operational table 54 and make them downloadable into the memory unit 25. It is also possible to constitute in such a way as to allow the user operate the operating panel unit 24 to set up a new table format.

Although it was described in the above that the digital copying machine 14 to print as an outputting process, it is also possible to out put the recognition result in the PDF file format in the memory medium for future use in addition to or in place of printing. The recognition result stored in the memory medium can be transmitted to a specified user by e-mail in response to the user's request in this case. This way, the user can post-edit the result.

Furthermore, the invention can be applied not only to the digital copying machine 14. For example, the image recognition technology according to this invention can be included as a part of the application software for conducting the OCR processing.

Moreover, it is possible for a computer to function as an image recognition device or an image scanning device by providing a program product on which the code data of the programmed character recognition method is recorded. For example, it is a computer that can communicate with the scanner 12 and the printer 13 via the network 11.

The program product includes the program and memory media that store the program. For example, the program is offered in memory media such as flexible disks and CD-ROMs and can be executed by installing them on a computer. Moreover, the program can be made to be downloaded from a server via the network 11 such as a LAN or the Internet, or to be executed directly.

What is claimed is:

1. A character recognition device comprising:
an extracting unit that extracts table areas from an image;
a character recognizing unit that recognizes character strings included in said table areas;
a converting unit that converts character strings consisting of numbers from the recognized character strings into numerical data;
a defining unit that defines operational expressions based on specific character strings from the recognized character strings;
an operational unit that calculates based on said numerical data and said operational expressions;
a comparing unit that compares calculated value provided by said operational unit with said numerical data; and
a reporting unit that reports mismatches when there are mismatches between said calculated value and said numerical data.

2. The character recognition device of the claim 1 wherein,
said reporting unit changes color attributes of character strings of which said calculated value do not match with said numerical data.

3. The character recognition device of the claim 1 further comprising:
a first memory unit that stores multiple table formats;
a second memory unit that stores operational expressions corresponding to each table format; and
a selecting unit that selects one of the table formats based on positional relations between rectangular frames in said table area and the recognized character strings.

4. The character recognition device of the claim 3 wherein,
said defining unit retrieve operational expressions that correspond to the table format selected by said selecting unit from said second memory unit.

5. The character recognition device of the claim 4 further comprising:
a first setup unit that sets up multiple table formats containing character strings that specify table structures and operation types; and
a second setup unit that sets up operational expressions for each table format.

6. The character recognition device of the claim 1 further comprising:
a first memory unit that stores character strings that specify types of operations;
a second memory unit that stores operational expressions corresponding to character strings that specify types of operations; and
a selecting unit that selects operational expressions with matching character strings that specify types of operations based on the recognized character strings.

7. The character recognition device of the claim 6 wherein,
said defining unit retrieve operational expressions selected by said selecting unit from said second memory unit.

8. The character recognition device of the claim 7 further comprising:
a first setup unit that sets up character strings that specify types of operations; and
a second setup unit that sets up operational expressions corresponding to character strings that specify types of operations.

9. The character recognition device of the claim 6 further comprising:
an identifying unit that identifies positions where character strings that specify types of operations.

10. The character recognition device of the claim 9 wherein,
said operational unit calculates according to the defined operational expressions in the column direction if said character strings exist in row labels that represent row headings in the table.

11. The character recognition device of the claim 9 wherein,
said operational unit calculates according to the defined operational expression in the row direction if said character strings exist in column labels that represents column headings in the table.

12. The character recognition device of the claim 1 wherein,
said character strings that specify types of operations contain “average,” “total,” “sum,” or “subtotal.”

13. An image reading device comprising:
a reading unit that reads a document and outputs its image data;
an extracting unit that extracts table areas from the outputted image data;
a character recognizing unit that recognizes character strings included in said table areas;
a converting unit that converts character strings consisting of numbers from the recognized character strings into numerical data;
a defining unit that defines operational expressions based on specific character strings from the recognized character strings;
an operational unit that calculates based on said numerical data and said operational expressions;
a comparing unit that compares calculated value provided by said operational unit with said numerical data;
a forming unit that forms an image that reports mismatches when there are mismatches between said calculated value and said numerical data; and
an output unit that outputs the image formed by the forming unit.

14. The image reading device of the claim 13 further comprising:
a printing unit that prints the image outputted from said output unit.

15. The image reading device of the claim 13 wherein,
said forming unit changes color attributes of a character string of which said calculated value do not match with said numerical data.

16. The image reading device of the claim 13 further comprising:
a first memory unit that stores multiple table formats;
a second memory unit that stores operational expressions corresponding to each table format; and
a selecting unit that selects one of the table formats based on positional relations between rectangular frames in said table area and the recognized character strings.

17. The image reading device of the claim 16 wherein,
said defining unit retrieve operational expressions that correspond to the table format selected by said selecting unit from said second memory unit.

18. The image reading device of the claim 17 further comprising:
a first setup unit that sets up multiple table formats containing character strings that specify table structures and operation types; and
a second setup unit that sets up operational expressions for each table format.

19. The image reading device of the claim 13 further comprising:
a first memory unit that stores character strings that specify types of operations;
a second memory unit that stores operational expressions corresponding to character strings that specify types of operations; and
a selecting unit that selects operational expressions with matching character strings that specify types of operations based on the recognized character strings.

20. The image reading device of the claim 19 wherein,
said defining unit retrieve operational expressions selected by said selecting unit from said second memory unit.

21. The image reading device of the claim 20 further comprising:
a first setup unit that sets up character strings that specify types of operations; and
a second setup unit that sets up operational expressions corresponding to character strings that specify types of operations.

22. The image reading device of the claim 19 further comprising:
an identifying unit that identifies positions where character strings that specify types of operations.

23. The image reading device of the claim 22 wherein,
said operational unit calculates according to the defined operational expressions in the column direction if said character strings exist in row labels that represent row headings in the table.

24. The image reading device of the claim 22 wherein,
said operational unit calculates according to the defined operational expression in the row direction if said character strings exist in column labels that represents column headings in the table.

25. The image reading device of the claim 13 wherein,
said character strings that specify types of operations contain “average,” “total,” “sum,” or “subtotal.”

26. A character recognition device comprising:
an extracting unit that extracts table areas from an image;
a character recognizing unit that recognizes character strings included in said table areas; and
an identifying means that identifies recognition errors committed by said character recognizing unit; wherein,
said identifying means including:
a converting unit that converts character strings consisting of numbers from the recognized character strings into numerical data;
a defining unit that defines operational expressions based on specific character strings from the recognized character strings;
an operational unit that calculates based on said numerical data and said operational expressions; and
a comparing unit that compares calculated value provided by said operational unit with said numerical data.

27. An image reading device comprising:
a reading unit that reads a document and outputs its image data;
an extracting unit that extracts table areas from the outputted image data;
a character recognizing unit that recognizes character strings included in said table areas; and
an identifying means that identifies recognition errors committed by said character recognizing unit; wherein,
said identifying means including:
a converting unit that converts character strings consisting of numbers from the recognized character strings into numerical data;
a defining unit that defines operational expressions based on specific character strings from the recognized character strings;
an operational unit that calculates based on said numerical data and said operational expressions; and
a comparing unit that compares calculated value provided by said operational unit with said numerical data.

28. A character recognition method comprising the steps of:
1) extracting table areas from an image;
2) recognizing character strings included in said table areas;
3) converting character strings consisting of numbers from the recognized character strings into numerical data;
4) defining operational expressions based on specific character strings from the recognized character strings;
5) calculating based on said numerical data and said operational expressions;
6) comparing calculated value with said numerical data; and
7) reporting mismatches when there are mismatches between said calculated value and said numerical data.

29. A storage medium readable by a computer for storing a program operable to recognize characters, the program comprising:
an extracting means that extracts table areas from an image;
a character recognizing means that recognizes character strings included in said table areas;
a converting means that converts character strings consisting of numbers from the recognized character strings into numerical data;
a defining means that defines operational expressions based on specific character strings from the recognized character strings;
an operational means that calculates based on said numerical data and said operational expressions;
a comparing means that compares calculated value provided by said operational means with said numerical data; and
a reporting means that reports mismatches when there are mismatches between said calculated value and said numerical data.

30. A computer program product for recognizing characters, the computer program products comprising:
a computer usable medium having computer readable program means embodied in said medium, said computer readable program means comprising:
an extracting means that extracts table areas from an image;
a character recognizing means that recognizes character strings included in said table areas;
a converting means that converts character strings consisting of numbers from the recognized character strings into numerical data;
a defining means that defines operational expressions based on specific character strings from the recognized character strings;
an operational means that calculates based on said numerical data and said operational expressions;
a comparing means that compares calculated value provided by said operational means with said numerical data; and
a reporting means that reports mismatches when there are mismatches between said calculated value and said numerical data.
